(19) United States
(12) Patent Application Publication
(10) Pub. No.: US 2010/0043671 A1
(43) Pub. Date: Feb. 25, 2010

(54) Bonding material treatment using sonification

(75) Inventor: Matthew Brett Wrosch, San Diego, CA (US)

Correspondence Address: THE NATH LAW GROUP, 112 South West Street, Alexandria, VA, 22314, US

(73) Assignee: AGUILA TECHNOLOGIES, San Marcos, CA (US)

(21) Appl. No.: 12/230,061

(22) Filed: Aug. 22, 2008

(51) Int. Cl. C09D 1/00; B01J 19/10

(52) U.S. Cl. 106/286.7; 204/157.42; 422/128

(57) ABSTRACT

A method and system for treating a material to enhance its properties is disclosed, particularly in the context of filler material for adhesives. The method and system includes ultrasonic treatment of the material in a solution and vacuum processing the material thereafter. The resulting material has been shown to exhibit at least one of increased thermal conductivity (˜50% gain) and reduced viscosity (˜50% reduction) as compared to non-treated material.

### BACKGROUND

1. Field

This disclosure relates to preparation of material for bonding. More particularly, it relates to ultrasonic treatment of material for increased filler properties.

2. Background

Ultrasonic treatment (sonification) of materials has been well studied for performing actual bonding of dissimilar materials to each other or for manipulating the overall geometry of a material. However, as detailed as these studies have been, there has not yet been any investigation into a process or system for producing a filler material having enhanced properties for bonding using ultrasonic means. Accordingly, methods and systems are provided herein that address these and other needs in the community.

### SUMMARY

Various aspects of the embodiments of this disclosure are detailed in the following description. In one aspect, a method for treating a material to enhance its properties as an adhesive filler is provided, comprising: immersing particles of material suitable for use as an adhesive filler in a solution; bombarding the material with ultrasonic energy for a predetermined period of time; draining the solution from the material; and placing the material in a vacuum for another predetermined period of time, wherein the resulting material exhibits at least one of increased thermal conductivity and reduced viscosity as compared to non-treated material.

In another aspect of the disclosed embodiments, an adhesive composition containing filler material is provided. The adhesive composition comprises, solder; and a filler material, the filler material being pre-treated for a predetermined period of time with ultrasonic energy while immersed in a solution, subsequently being drained and held in a vacuum for another predetermined period of time, wherein the filler material exhibits at least one of increased thermal conductivity and reduced viscosity as compared to non-treated filler material.

In yet another aspect, a system for treating a material to enhance its properties as an adhesive filler is disclosed, comprising: a container; particles of a material suitable for use as an adhesive filler within the container; a solution immersing the material in the container; an ultrasonic generator, wherein the material is bombarded with ultrasonic energy by the ultrasonic generator for a predetermined period of time with the material subsequently drained and placed in a vacuum, the system producing a filler material exhibiting at least one of increased thermal conductivity and reduced viscosity as compared to non-treated filler material.

### BRIEF DESCRIPTION OF THE DRAWING

FIG. 1 is a flow diagram showing an exemplary method.

FIGS. 2A-B are block diagrams illustrating an exemplary system for performing the method of FIG. 1.

### DETAILED DESCRIPTION

Overview

The current literature regarding ultrasonic applications (sonification) is pre-disposed to understanding the actual physical mechanisms by which sonification affects materials. It is understood that physical forces are exerted upon materials that are exposed to ultrasonic waves traveling within a liquid. In some instances, the vibration of the mechanical energy transmitted by the ultrasonic waves generates molecular friction in the material, causing fusion between the surfaces of the vibrated materials that are in contact with each other. In other instances, the vibration serves to agitate the liquid-to-solid boundary causing cavitation at the interface, rather than actual vibration of the material's structure. In other cases, the ultrasonic vibration alters the shape of the material at a molecular level. Various physical effects are manifested depending on the intensity or frequency of the ultrasonic radiation, as well as the type or temperature of the medium used, and the properties, size, or structure of the material.

In view of the above, several practitioners have attempted to exploit ultrasonic methodologies for bonding purposes. For example, U.S. Pat. No. 5,116,433 to Davis et al. describes a metal based solder alloy that is provided in the form of solder spheres. The solder alloy is initially cleaned in a solvent such as acetone to remove any grease or organic residues, upon which it is rinsed with deionized water utilizing ultrasonic agitation. After this initial cleaning, the solder alloy is placed in a beaker and covered with formic acid (or equivalent solution), and then heated to generate a metal formate on the solder surface to serve as an oxygen scavenger.

U.S. Pat. No. 4,717,430 to Beal describes a method of fluxlessly joining metal surfaces with a zinc-based composition. The metal surfaces to be coated are placed in a molten bath of the zinc-based composition. The bath is ultrasonically treated causing cavitation in the molten composition to remove oxides from the parts and allows the composition to coat the clean surfaces to form the bond.

Suslick and Price in their “Applications of Ultrasound to Materials Chemistry” investigate the effects of ultrasound on inorganic materials. Particularly, cavitation (bubble collapse) is understood to be the physical mechanism that sends shock waves through a liquid-solid slurry. Because of the shock waves, high-velocity interparticle collisions can occur, resulting in the mechanical removal of surface material on the solids. The effective transient temperature reached at the point of impact during interparticle collisions can reach as high as 3000° C.

Description

Current state-of-the-art bonding and/or material preparation for bonding is expanded by disclosing systems and methods for at least ultrasonically treating a metal in a powdered state while immersed in a low-viscosity, non-oxidizing medium, where the medium is drained after sonification, and the metal is held in a vacuum until its use as a filler in forming one of an adhesive or solder-type bond.

Additionally, methods and systems are disclosed for at least ultrasonically treating a metal in a powdered state while immersed in a low-viscosity, non-oxidizing medium in the absence of solder particles, where the metal is subsequently used as a filler in combination with solder particles, and where the ultrasonic radiation raises the temperature of the medium above the melting point of the solder particles. The resulting product is a highly deoxidized bonding material, as further detailed below.

In one embodiment, spheres or powder particles of copper or another metal are provided where the metal is immersed in a low-viscosity, non-oxidizing medium such as acetone, chlorophyll, isopropyl alcohol, or the like. It is understood that other non-oxidizing media may be used according to design preference. The other metals may have varying sizes (i.e., non-spherical or non-powder form) as well as being silver, gold, aluminum and so forth. An ultrasonic sonifier is engaged which disperses ultrasonic waves in the medium for a fixed period of time. The metal is then drained and held under vacuum. The metal can then be combined with a solder powder, to serve as a high melting point filler when forming a solder-type bond. Laser-flash analyses of bonds formed with this treated metal reveal improved thermal conductivity over non-treated metal/solder powder combinations.

It is believed that the ultrasonic radiation causes cavitation in the medium. When cavitation occurs near the spheres or powder particles, it generates high-speed jets of liquid which interact with the metal or metal oxide. This cavitation is believed to remove oxidization from the outside of the metal, either by directing these high speed jets across the surface of the metal spheres or powder particles to expose new reactive surfaces, or by causing the metal spheres or powder particles to impact each other to arrive at a similar effect.

By sonifying the filler metals but not the solder materials itself, sonification may occur for extended periods of time, thus alleviating concerns that may arise when sonifying the actual solder materials.

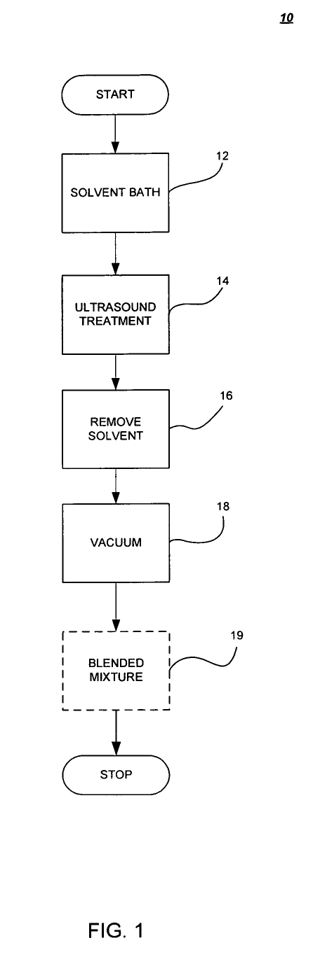

FIG. 1 is a flow diagram 10 showing an exemplary process for filler preparation. The exemplary process begins by placing filler material in a solvent bath 12, forming a solid-liquid slurry. In a tested scenario, the solvent chosen was acetone because of its quick flash rate. However, as stated above, another solvent type or form of bath may be used without departing from the spirit and scope of this disclosure. Further, while the term solvent is used, it is understood that another bath material not having solvent-like properties, whether liquid or semi-liquid in form may be used. Thus, it is explicitly understood that other liquids or semi-liquid baths having the capability to propagate sound waves and also provide some degree of “scrubbing” of the filler material may be used, according to design preference.

Also in the tested scenario, the filler material used was copper powder of electronic grade 3124 from Ultrafine Powders. Of course, the filler material may be of another metal, including varying sizes, non-limiting examples being silver, gold, aluminum and so forth, or non-metal materials that can also operate as filler materials. After the filler material is placed in the “solvent” bath, it is subjected to ultrasound treatment 14. The ultrasound treatment 14 used in the tested scenario was performed with a sonifier manufactured by Sonics and Materials, operating at approximately 20 kHz. However, it is understood that other frequencies may be utilized, according to design preference.

The ultrasound treatment was performed for an extended period of time ranging from 1 hour to 3 or more hours. It is believed that sonification results in the elimination of oxide at the surface of the filler material 24 to collisions, or, alternatively, that the oxide layer is compressed by the collisions resulting in a smoother surface and perhaps one with higher surface energy (hence the greater propensity to react with solder and lower viscosity).

After a given period of time, the solvent is removed 16 from the solvent bath 12 and the resulting solvent-reduced slurry is subjected to a vacuum 18. The vacuum 18 operates to significantly or completely remove residual solvent left in the filler material slurry. The now-treated filler material, having the solvent removed (for all practical purposes), is then optionally blended 19 with solder to form a highly thermally conductive soldering compound/adhesive. The last step 19 is shown in FIG. 1 as an optional step and may be performed in accordance with procedures described in U.S. Patent Application Publication No. 2006/0194920, by Capote et al., titled “Thermally Conductive Adhesive Composition and Process for Device Attachment”, filed Aug. 31, 2006, the contents of which are expressly incorporated by reference herein.

The result of this activity is that the resulting adhesive paste demonstrated significantly higher thermal conductivity (˜50% gain) as compared to formulations which incorporated identical copper that was not sonified. This was verified with a Netzsch laser-flash system. Further, the room temperature viscosity was reduced by ˜50% as compared to formulations that incorporated copper that was not sonified. This was verified with a Brookfield viscometer DV-II using a cone and plate attachment (CP52).

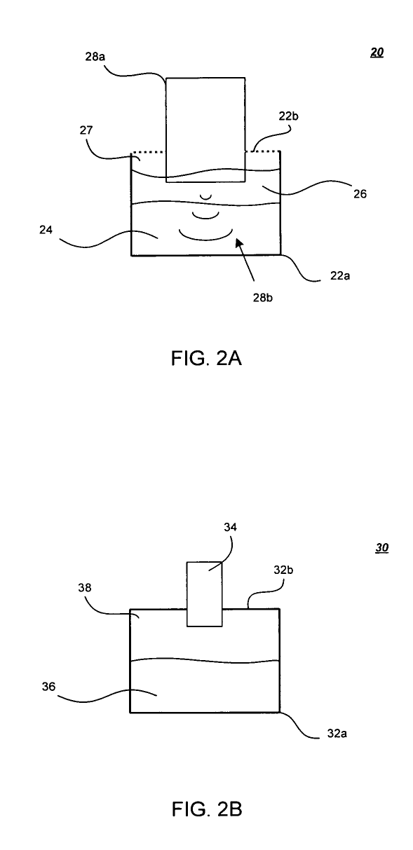

FIGS. 2A-B are block diagrams 20 and 30, respectively, illustrating an exemplary system for performing the exemplary method of FIG. 1. In FIG. 2A, a filler material 24 is placed within a container 22a through the container's open face 22b. A solution 26 is then poured into the container 22a to cover the material 24. In some instances, the solution 26 need only cover the material 24 or may cover the material 24 by a substantial amount. In some instances, the container 22a may be filled with the solution 26 or partially filled 27 as seen in FIG. 2A.

It should be understood that in some embodiments, the material 24 may be in suspension within the solution 26. Therefore, the boundary between the material 24 and solution 26 may not be distinct, as seen, for example, in FIG. 2A.

A sonifying device 28a, typically of the ultrasonic frequency range, is positioned within the solution 26 or the equivalent liquid-solid slurry. The resulting ultrasonic waves 28b bombard the material 24, resulting in what is believed to be violent particle-to-particle collisions in addition to very high localized heat from collapsing bubbles. The material 24 is exposed to the sound waves 28b for a predetermined period of time.

Now in FIG. 2B, after the predetermined amount of sonification, the solution 26 is removed from the container 22a and the now-sonified material 36 is placed in a vacuum-capable container 32a. Depending on the quantity of material 36 and the size of the container 32a, there may exist a gap 38 between the top of the material 36 and the top 32b of the container 32a. In some instances, the container 22a of FIG. 2A may be the same container 32a of FIG. 2B, depending on the type of container used. That is, the container 22a may be a vacuum-capable container. A device or inlet 34 capable of creating a vacuum is positioned in the interior of the container 32a and is thereafter engaged, resulting in any residual solution 26 in the material 36 to be removed. The vacuum may be present for a predetermined period of time.

As noted above, the resulting filler material has been shown to exhibit significantly higher thermal conductivity (˜50% gain) as compared to non-sonified copper formulations. Also, room temperature viscosity has been shown to be reduced by ˜50% as compared to non-sonified copper formulations. Because of its superior or enhanced characteristics, the resulting filler material can then blended with solder to form a superior soldering compound.

Other uses for, or products which may be enhanced with the addition of the exemplary filler material are deemed possible. Therefore, limitation on its use or application to only that of a filler material for solder should not be made. Also, while the experimental results are arrived at using copper as the constituent material, other materials suitable as a filler or having a relative sensitivity to that of copper may be utilized according to design preference. As it is imagined that the combined ultrasonic treatment and vacuuming processes act to treat the surfaces of the filler material, altering its surface's physical or chemical properties (whether removing oxides or affecting its bonding, and so forth), other materials that are not metallic may be similarly treated to result in a material having enhanced properties.

Based on the above, it should be understood that variations to the embodiments and procedures described may be made without departing from the scope of this disclosure. For example, the sonifier 28a may be mated to a side wall of the container 22a, or may be integral to the container 22a. Further, there may be some gross agitation of the solid-liquid slurry via a paddle or stirrer to bring more of the material 24 into the path of the ultrasonic waves 28b. Also, the ultrasonic waves 28b may be operated at varying frequencies depending on the desired effects. Accordingly, there are many possible ways to modify or enhance the disclosed mechanisms for achieving a superior material using sonification and vacuum processing.

Thus, it will be understood that many additional changes in the details, materials, steps and arrangement of parts, which have been herein described and illustrated to explain the nature of the disclosed subject, may be made by those skilled in the art within the principle and scope of the subject matter as expressed in the appended claims.

What is claimed is:

1. A method for treating a material to enhance its properties as an adhesive filler, comprising:
immersing particles of material suitable for use as an adhesive filler in a solution;
bombarding the material with ultrasonic energy for a predetermined period of time;
draining the solution from the material; and
placing the material in a vacuum for another predetermined period of time, wherein the resulting material exhibits at least one of increased thermal conductivity and reduced viscosity as compared to non-treated material.

2. The method of claim 1, wherein the solution is a solvent.

3. The method of claim 2, wherein the solvent is acetone.

4. The method of claim 1, wherein the material is copper.

5. The method of claim 1, wherein the ultrasonic energy is at a frequency of approximately 20 kHz.

6. The method of claim 1, further comprising adding the resulting material to a solder.

7. The method of claim 1, wherein the material is bombarded for at least 0.5 hours.

8. An adhesive composition containing filler material, comprising:
solder; and
a filler material, the filler material being pre-treated for a predetermined period of time with ultrasonic energy while immersed in a solution, subsequently being drained and held in a vacuum for another predetermined period of time, wherein the filler material exhibits at least one of increased thermal conductivity and reduced viscosity as compared to non-treated filler material.

9. The adhesive composition of claim 8, wherein the solution is a solvent.

10. The adhesive composition of claim 9, wherein the solvent is acetone.

11. The adhesive composition of claim 8, wherein the filler material is copper.

12. The adhesive composition of claim 8, wherein the ultrasonic energy is at a frequency of approximately 20 kHz.

13. The adhesive composition of claim 8, wherein the material is bombarded for at least 2 hours.

14. A system for treating a material to enhance its properties as an adhesive filler, comprising:
a container;
particles of a material suitable for use as an adhesive filler within the container;
a solution immersing the material in the container;
an ultrasonic generator,
wherein the material is bombarded with ultrasonic energy by the ultrasonic generator for a predetermined period of time with the material subsequently drained and placed in a vacuum, the system producing a filler material exhibiting at least one of increased thermal conductivity and reduced viscosity as compared to non-treated filler material.

15. The system of claim 14, wherein the solution is a solvent.

16. The system of claim 15, wherein the solvent is acetone.

17. The system of claim 14, wherein the material is copper.
